(19) United States
(12) Patent Application Publication
(10) Pub. No.: US 2019/0093577 A1
(43) Pub. Date: Mar. 28, 2019

(54) CONTROLLER AND CONTROL METHOD FOR INTERNAL COMBUSTION ENGINE

(71) Applicant: TOYOTA JIDOSHA KABUSHIKI KAISHA, Toyota-shi (JP)

(72) Inventor: Junichi MORI, Nagakute-shi (JP)

(73) Assignee: TOYOTA JIDOSHA KABUSHIKI KAISHA, Toyota-shi (JP)

(21) Appl. No.: 16/103,229

(22) Filed: Aug. 14, 2018

(30) Foreign Application Priority Data
Sep. 26, 2017 (JP) 2017-184818

(51) Int. Cl. F02D 41/02

(52) U.S. Cl. CPC F02D 41/022; F02D 41/023

(57) ABSTRACT

A controller for an internal combustion engine is configured to control a vehicle internal combustion engine having a crankshaft connected to a manual transmission via a clutch. The controller is configured to execute a feedback process, a torque control process, an assist process, a fixing process, and a gradual decrease process. The fixing process includes fixing a correction coefficient at a specified value on condition that the clutch is in a transition period from the disengaged state to the engaged state. The gradual decrease process includes stopping the fixing process and gradually decreasing the correction coefficient to the feedback operation amount when the fixing process is executed and the assist torque is smaller than or equal to a predetermined value.

### CROSS REFERENCE TO RELATED APPLICATION

This application claims priority from Japanese Patent Application No. 2017-184818, filed on Sep. 26, 2017, the disclosure of which is incorporated herein by reference in its entirety.

### BACKGROUND ART

The present disclosure relates to a controller and control method configured to control a vehicle internal combustion engine of which the crankshaft is connected to a manual transmission via a clutch.

For example, Japanese Laid-Open Patent Publication No. 2014-190178 discloses a controller. The controller calculates a clutch load torque, which is a load torque applied to the crankshaft from the input shaft of the manual transmission through the clutch during a transition period from the clutch disengaged state to the clutch engaged state. The controller also generates a torque request for the internal combustion engine in accordance with the assist torque corresponding to the clutch load torque.

### SUMMARY

The inventor gave consideration to a process of continuously calculating a feedback operation amount of the idle speed control so as to cope with a situation in which the operation of the accelerator is insufficient at the time of starting the vehicle. When using a feedback operation amount as a correction coefficient of a base torque including an assist torque, the base torque including the assist torque is reduced in some cases depending on the value of the feedback operation amount. In such a case, the actual torque becomes smaller than a torque determined in accordance with the assist torque, which is set as an appropriate torque during the transition period to the engaged state of the clutch, which reduces the assisting performance. Therefore, when using assist torque, it is conceivable to set the correction coefficient for correcting the assist torque to a fixed value instead of a feedback operation amount. In that case, however, if the correction coefficient is returned to the feedback operation amount when the assist by the assist torque is cancelled, the torque of the internal combustion engine abruptly drops, which may cause the user to experience discomfort.

### EXAMPLE 1

In accordance with one aspect of the present disclosure, a controller is provided that is configured to control a vehicle internal combustion engine having a crankshaft connected to a manual transmission via a clutch. The controller is configured to execute a feedback process, a torque control process, an assist process, a fixing process, and a gradual decrease process. The feedback process calculates a feedback operation amount, which is an operation amount used to perform feedback control to set a rotational speed of the crankshaft of the internal combustion engine to a target rotational speed. The torque control process controls a torque of the internal combustion engine by using, as an input, an idle required torque, which is a value obtained by multiplying a base torque by a correction coefficient. The assist process raises the base torque by an assist torque, which is a torque used to limit a decrease in the rotational speed of the crankshaft that accompanies transition of the clutch from a disengaged state to an engaged state. The fixing process fixes the correction coefficient at a specified value on condition that the clutch is in a transition period from the disengaged state to the engaged state. The gradual decrease process stops the fixing process and gradually decreases the correction coefficient to the feedback operation amount when the fixing process is executed and the assist torque is smaller than or equal to a predetermined value.

In the above described configuration, the correction coefficient is fixed on condition that the clutch is in the transition period, so that the base torque, which has been raised by the assist torque, is prevented from being an excessively small value due to the course of the feedback operation amount. Further, since the correction coefficient is gradually decreased to the feedback operation amount when the assist torque is smaller than or equal to the predetermined value, it is possible to limit the drop of the idle required torque as compared with a case in which the correction coefficient is changed in a stepwise manner to the feedback operation amount. This prevents the torque of the internal combustion engine from being reduced abruptly.

### EXAMPLE 2

In the controller for an internal combustion engine of Example 1, the fixing process is a process of fixing the correction coefficient at the specified value when following two conditions are met: a condition that the clutch is in the transition period; and a condition that an accelerator is being operated. Also, the controller is configured to use the feedback operation amount as the correction coefficient when the fixing process is not executed.

Although the execution of the feedback process suppresses the rotational fluctuation of the internal combustion engine, the decrease in the base torque, which has been raised by the assist torque, by the feedback operation amount reduces the assisting performance. In particular, when the accelerator is operated, the user is assumed to intend to increase the torque of the internal combustion engine. Thus, reduction in the assisting performance may cause the user to experience discomfort. Accordingly, the fixing process is executed on condition that the accelerator is operated in the above-described configuration. This achieves compatibility between suppression of reduction in the assisting performance and suppression of rotational fluctuation.

### EXAMPLE 3

In the controller for an internal combustion engine of Example 1 or Example 2, the controller is configured to execute the fixing process on condition that the feedback operation amount is smaller than a specified value. The controller is also configured to, in a case in which the feedback operation amount is greater than the specified value, use the feedback operation amount as the correction coefficient even if the clutch is in the transition period.

For example, when the vehicle comes to an uphill road as the vehicle starts moving, the base torque raised by the assist torque may be is insufficient in relation to the adequate torque at the time of starting. In such a case, the rotation speed of the crankshaft decreases. Since decrease in the rotation speed increases the feedback operation amount, the feedback operation amount is expected to exceed the specified value. In the above-described configuration, the correction coefficient is set to the feedback operation amount when the feedback operation amount exceeds the specified value. Thus, the idle required torque can be increased as compared to a case in which the correction coefficient is set to the specified value.

### EXAMPLE 4

In the controller for an internal combustion engine of any one of Examples 1 to 3, the controller is configured to, in a case in which the feedback operation amount is smaller than the specified value, execute a gradual increase process of gradually increasing the correction coefficient from the value of the feedback operation amount to the specified value prior to starting of the fixing process.

If the feedback operation amount is significantly smaller than the specified value when the correction coefficient is changed in a stepwise manner to the specified value, the idle required torque is changed in a stepwise manner. In that case, the torque of the internal combustion engine is increased in a discontinuous manner. In contrast, in the above-described configuration, the execution of the gradual increase process allows the idle required torque to be increased gradually, thereby limiting abrupt change of the torque of the internal combustion engine.

### EXAMPLE 5

In the controller for an internal combustion engine of any one of Examples 1 to 4, the assist process includes a process of: during the transition period, calculating the assist torque to be a greater value when a decrease rate of the rotational speed of the crankshaft is high than when the decrease rate is low; and gradually decreasing the assist torque to zero when the transition period is complete and the clutch is in the engaged state.

When the load torque applied to the crankshaft by the clutch is great, the decrease rate of the rotation speed of the crankshaft is high. Thus, the decrease rate of the rotation speed can be used as a parameter for determining the load torque. Accordingly, in the above-described configuration, the assist torque is calculated to be a greater value when the decrease rate of the rotation speed of the crankshaft is high than when the decrease rate is low, so that the assist torque can be set to a value corresponding to the load torque. Also, in the above-described configuration, the assist torque is gradually decreased to zero when the transition period of the clutch is complete and the clutch is in the engaged state, abrupt change in the idle required torque is suppressed as compared with a case in which the assist torque is changed in a stepwise manner to zero. This limits abrupt change of the torque of the internal combustion engine.

### EXAMPLE 6

In the controller for an internal combustion engine of any one of Examples 1 to 5, the controller is configured to execute an accelerator required torque calculation process of calculating an accelerator required torque of the internal combustion engine in accordance with an accelerator operation amount. The torque control process includes a process of: using the accelerator required torque as an input in addition to the idle required torque; and controlling the torque of the internal combustion engine in accordance with a greater one of the idle required torque and the accelerator required torque.

If the accelerator operation amount is excessively small when the calculation of the feedback operation amount is stopped through operation of the accelerator, the torque of the internal combustion engine may become smaller than when the torque is controlled in accordance with the idle required torque without operation of the accelerator. In such a case, there is a possibility that the user will experience discomfort about operation of the accelerator. Accordingly, in the above-described configuration, the torque is controlled based on the greater one of the idle required torque and the accelerator required torque, so that the user is prevented from experiencing discomfort about operation of the accelerator.

### EXAMPLE 7

In the controller for an internal combustion engine of any one of Examples 1 to 6, the gradual decrease process includes a process of setting a gradual decrease rate of the correction coefficient to a smaller value when a vehicle speed is low than when the vehicle speed is high.

When the gradual decrease rate is high for a low vehicle speed, reduction in the torque of the internal combustion engine due to the gradual decrease in the correction coefficient may cause the user to experience discomfort. Accordingly, in the above-described configuration, the gradual decrease rate is set to be lower when the vehicle speed is low than when the vehicle speed is high. This allows the gradual decrease rate to be set adequately in accordance with the vehicle speed, thereby preventing the user from experiencing discomfort due to gradual decrease in the correction coefficient.

### EXAMPLE 8

In accordance with another aspect of the present disclosure, a control method is provided that controls a vehicle internal combustion engine having a crankshaft connected to a manual transmission via a clutch. The method includes executing a feedback process, executing a torque control process, executing an assist process, executing a fixing process, and executing a gradual decrease process. The feedback process is a process of calculating a feedback operation amount, which is an operation amount used to perform feedback control to set a rotational speed of the crankshaft of the internal combustion engine to a target rotational speed. The torque control process is a process of controlling a torque of the internal combustion engine by using, as an input, an idle required torque, which is a value obtained by multiplying a base torque by a correction coefficient. The assist process is process of raising the base torque by an assist torque, which is a torque used to limit a decrease in the rotational speed of the crankshaft that accompanies transition of the clutch from a disengaged state to an engaged state. The fixing process is a process of fixing the correction coefficient at a specified value on condition that the clutch is in a transition period from the disengaged state to the engaged state. The gradual decrease process is a process of stopping the fixing process and gradually decreases the correction coefficient to the feedback operation amount when the fixing process is executed and the assist torque is smaller than or equal to a predetermined value.

### EXAMPLE 9

In accordance with a further aspect of the present disclosure, a controller for an internal combustion engine is provided that is configured to control a vehicle internal combustion engine having a crankshaft connected to a manual transmission via a clutch. The controller includes processing circuitry. The processing circuitry is configured to execute a feedback process, a torque control process, an assist process, a fixing process, and a gradual decrease process. The feedback process is a process of calculating a feedback operation amount, which is an operation amount used to perform feedback control to set a rotational speed of the crankshaft of the internal combustion engine to a target rotational speed. The torque control process is a process of controlling a torque of the internal combustion engine by using, as an input, an idle required torque, which is a value obtained by multiplying a base torque by a correction coefficient. The assist process is process of raising the base torque by an assist torque, which is a torque used to limit a decrease in the rotational speed of the crankshaft that accompanies transition of the clutch from a disengaged state to an engaged state. The fixing process is a process of fixing the correction coefficient at a specified value on condition that the clutch is in a transition period from the disengaged state to the engaged state. The gradual decrease process is a process of stopping the fixing process and gradually decreases the correction coefficient to the feedback operation amount when the fixing process is executed and the assist torque is smaller than or equal to a predetermined value.

Other aspects and advantages of the present disclosure will become apparent from the following description, taken in conjunction with the accompanying drawings, illustrating exemplary embodiments.

### BRIEF DESCRIPTION OF THE DRAWINGS

The disclosure may be understood by reference to the following description together with the accompanying drawings:

FIG. 1 is a diagram showing a controller according to a first embodiment and an internal combustion engine;

FIG. 2 is a block diagram showing part of processes executed by the controller of the embodiment;

FIG. 3 is a flowchart showing the procedure of a process of calculating an assist torque according to the embodiment;

FIG. 4 is a flowchart showing the procedure of a process of calculating a correction coefficient according to the embodiment;

FIG. 5 is a timing diagram showing a problem to be solved by the embodiment;

FIG. 6 is a timing diagram showing an advantage of the embodiment;

FIG. 7 is a timing diagram showing a problem to be solved by the embodiment; and

FIG. 8 is a diagram showing data used to set a decrease amount according to the second embodiment.

### DETAILED DESCRIPTION

### First Embodiment

A controller for an internal combustion engine according to a first embodiment will now be described with reference to the drawings.

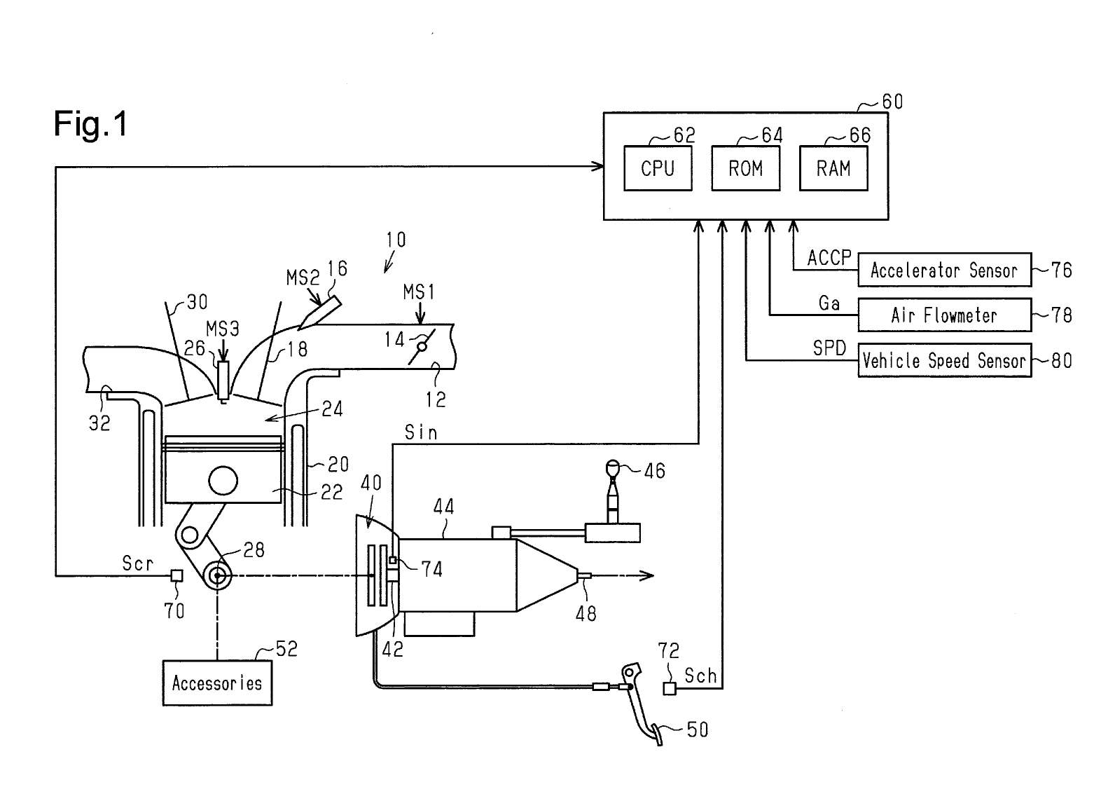

As shown in FIG. 1, the internal combustion engine 10 includes a throttle valve 14 arranged in an intake passage 12 and a fuel injection valve 16 provided downstream of the throttle valve 14. The fuel injected from the fuel injection valve 16 and the air drawn into the intake passage 12 flow into a combustion chamber 24, which is defined by a cylinder 20 and a piston 22, as an intake valve 18 is opened. The air-fuel mixture drawn into the combustion chamber 24 is burned by the spark discharge of an ignition device 26. The energy generated by combustion is converted into the rotational energy of a crankshaft 28 via the piston 22. The burned air-fuel mixture is discharged to an exhaust passage 32 as exhaust gas when an exhaust valve 30 is opened.

The crankshaft 28 is connected to an input shaft 42 of a manual transmission 44 via a clutch 40. The manual transmission 44 variably sets the gear ratio, which is the ratio of the rotational speed of the input shaft 42 and the rotational speed of an output shaft 48, when the user operates a shift lever 46. Through operation of a clutch pedal 50, the clutch 40 switches between an engaged state, in which the crankshaft 28 and the input shaft 42 are rotated integrally, and a disengaged state, in which the power transmission between the crankshaft 28 and the input shaft 42 is interrupted.

The output shaft 48 of the manual transmission 44 is connected to the drive wheels. The crankshaft 28 is also connected to accessories 52 such as the alternator and the compressor of the vehicle air conditioner.

The controller 60 is configured to control the internal combustion engine 10. The controller 60 is configured to control the controlled portions of the engine 10 such as the throttle valve 14, the fuel injection valve 16, and the ignition device 26, thereby controlling control amounts such as the torque and the exhaust components. The control of the control amounts includes setting of the air-fuel ratio of the air-fuel mixture to be burned in the combustion chamber 24 to a target air-fuel ratio.

When controlling control amounts, the controller 60 refers to an output signal Scr of a crank angle sensor 70, an output signal Sch of a clutch sensor 72, which binarily detects whether the clutch pedal 50 has been stepped on, and an output signal Sin of an input rotation angle sensor 74, which detects the rotation angle of the input shaft 42. Further, the controller 60 refers to the operation amount of the accelerator pedal detected by an accelerator sensor 76 (accelerator operation amount ACCP), an intake air amount Ga detected by an air flowmeter 78, and a vehicle speed SPD detected by a vehicle speed sensor 80. Based on operation of the clutch pedal 50, the clutch sensor 72 detects whether the clutch 40 is in an engaged state or a disengaged state. When the value of the accelerator operation amount ACCP is great, the required torque of the internal combustion engine 10 is increased.

The controller 60 includes a CPU 62, a ROM 64, and a RAM 66 and is configured to execute control of the above-described control amounts by executing programs stored in the ROM 64 using the CPU 62.

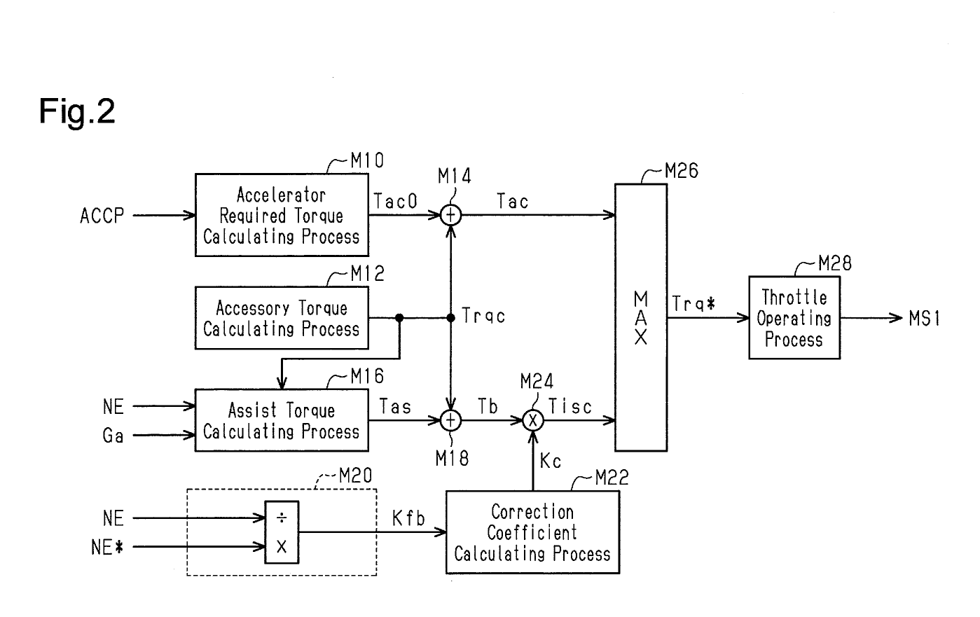

FIG. 2 shows part of the processes executed by controller 60. The process shown in FIG. 2 is implemented by the CPU 62 executing programs stored in the ROM 64.

An accelerator required torque calculating process M10 is a process of calculating and outputting an accelerator required torque Tac0, which is the torque required of the internal combustion engine 10, based on the accelerator operation amount ACCP. An accessory torque calculating process M12 is a process of calculating an accessory torque Trqc, which is the load torque applied to the crankshaft 28 by the accessories 52. Specifically, the load torque generated by the friction between the piston 22 and the cylinder 20 is also included in the accessory torque Trqc for convenience sake in the present embodiment. An adding process M14 calculates an accelerator required torque Tac by adding the accessory torque Trqc to the accelerator required torque Tac0. The accelerator required torque Tac is the torque required of the internal combustion engine 10 to cause the power applied to the drive wheels by the internal combustion engine 10 to be an amount corresponding to the accelerator operation amount ACCP.

An assist torque calculating process M16 calculates an assist torque Tas, which limits a drop of the rotational speed of the crankshaft 28 due to an increase in the load torque applied to the crankshaft 28 by the clutch 40 during a transition period from the disengaged state to the engaged state of the clutch 40. The transition period corresponds to a period during which the clutch 40 is in the partially engaged state.

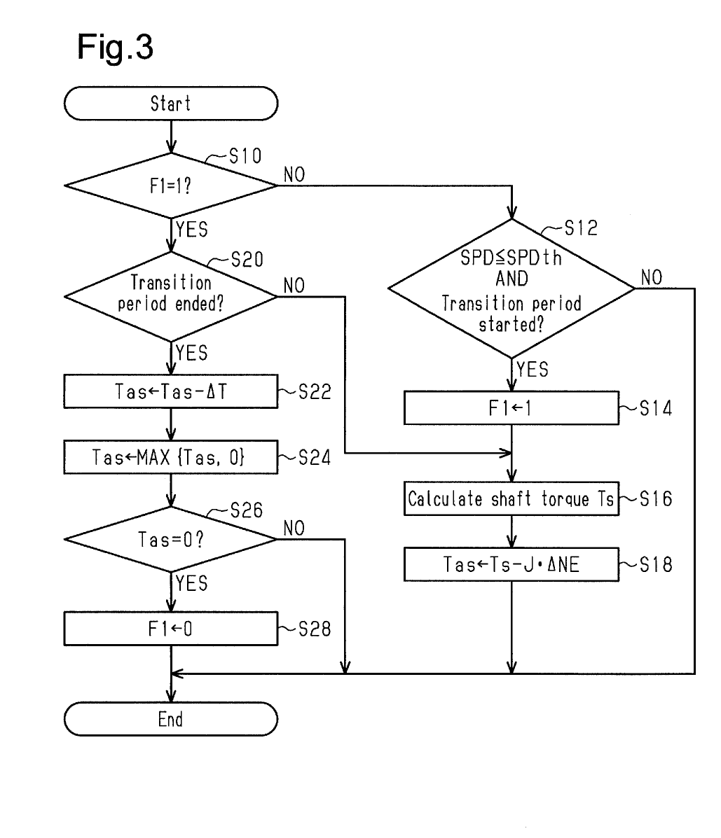

FIG. 3 shows the procedure of the assist torque calculating process M16. The process shown in FIG. 3 is executed by the CPU 62 repeatedly executing programs stored in the ROM 64 at a predetermined interval. In the following description, the number of each step is represented by the letter S followed by a numeral.

In the series of processes shown in FIG. 3, the CPU 62 first determines whether an assist flag F1 is 1 (S10). The assist flag F1 is set to 1 during the period of providing the assist torque Tas and is set to 0 during the period other than the period of providing the assist torque Tas. When determining that the assist flag F1 is 0 (S10: NO), the CPU 62 determines whether the following two conditions are met: the condition that the vehicle speed SPD is lower than or equal to a specified speed SPDth; and the condition that the transition period from the disengaged state of the clutch 40 to the engaged state has started (S12). This process is a process of determining the start timing of the period of providing the assist torque Tas. The specified speed SPDth is set to a value about the maximum value assumed for the speed at the time of starting the vehicle. The CPU 62 determines whether the transition period has been started based on the rotational speed NE of the crankshaft 28 calculated based on the output signal Scr and the rotational speed Nin of the input shaft 42 calculated based on the output signal Sin. For example, when the vehicle speed SPD is zero, the rotational speed Nin of the input shaft 42 is zero. In contrast, the rotational speed Nin is changed to a value greater than zero and smaller than the rotational speed NE during the transition period from the disengaged state to the engaged state of the clutch 40. Whether the transition period is being started can be determined based on these points.

When determining that the above listed two conditions are met (S12: YES), the CPU 62 sets the assist flag F1 to 1 (S14). Next, the CPU 62 calculates a shaft torque Ts of the internal combustion engine 10 based on the rotational speed NE, the intake air amount Ga, and the accessory torque Trqc (S16). The rotational speed NE and the intake air amount Ga are parameters for obtaining the amount of air filling the combustion chamber 24. Since the CPU 62 controls the air-fuel ratio of the air-fuel mixture to the target air-fuel ratio, the CPU 62 can obtain the indicated torque of the internal combustion engine 10 based on the amount of air filling the combustion chamber 24. The CPU 62 can also obtain the shaft torque Ts as the value obtained by subtracting the accessory torque Trqc from the indicated torque.

Next, the CPU 62 subtracts, from the shaft torque Ts, a value obtained by multiplying the moment of inertia J of the internal combustion engine 10 by the change rate ΔNE of the rotational speed NE and substitutes the resultant for the assist torque Tas (S18). This is based on the relationship that the shaft torque Ts is equal to the sum of the load torque by the clutch 40 and J·ΔNE. In the process of S18, the CPU 62 sets the assist torque Tas to the torque corresponding to the clutch load torque, which is the load torque applied to the crankshaft 28 by the clutch 40. Since the clutch load torque is greater when the decrease rate of the rotational speed NE of the crankshaft 28 is high than when the rotational speed NE is low, the assist torque Tas also has a greater value. The decrease rate is a value obtained by multiplying the change rate ΔNE by −1.

When determining that the assist flag F1 is 1 (S10: YES), the CPU 62 determines whether the transition period has ended based on the output signal Sch of the clutch sensor 72 (S20). When determining that the transition period has not ended (S20: NO), the CPU 62 proceeds to the process of S16.

In contrast, when determining that the transition period has ended (S20: YES), the CPU 62 performs correction to decrease the assist torque Tas by the decrease amount ΔT (S22). Next, the CPU 62 substitutes the greater one of the assist torque Tas and 0 for the assist torque Tas (S24). This is a process of setting the assist torque Tas to a value greater than or equal to zero. Next, the CPU 62 determines whether the assist torque Tas is zero (S26). When determining that the assist torque Tas is zero (S26: YES), the CPU 62 sets the assist flag F1 to 0 (S28).

When the processes of S18, S28 are complete or when the determinations are negative in the processes of S12, S26, the CPU 62 temporarily ends the series of processes shown in FIG. 3.

Referring back to FIG. 2, the adding process M18 calculates a base torque Tb by adding the accessory torque Trqc to the assist torque Tas. A feedback process M20 calculates a feedback operation amount Kfb by dividing the target rotational speed NE* by the rotational speed NE. A correction coefficient calculating process M22 uses the feedback operation amount Kfb as an input to calculate a correction coefficient Kc of the base torque Tb. A multiplying process M24 calculates an idle required torque Tisc by multiplying the base torque Tb by the correction coefficient Kc.

A maximum value selecting process M26 outputs the greater one of the accelerator required torque Tac and the idle required torque Tisc as a required torque Trq*. When the accelerator required torque Tac and the idle required torque Tisc are equal to each other, the required value Trq* is set to that equal torque.

A throttle operating process M28 outputs an operation signal MS1 to the throttle valve 14 in order to operate the opening degree of the throttle valve 14 based on the required torque Trq*. The throttle operating process M28 causes the opening degree of the throttle valve 14 to be greater when the required torque Trq* is great than when the required torque Trq* is small. Accordingly, the amount of air filling the combustion chamber 24 is greater when the required torque Trq* is great than that when the required torque Trq* is small, so that the torque is increased.

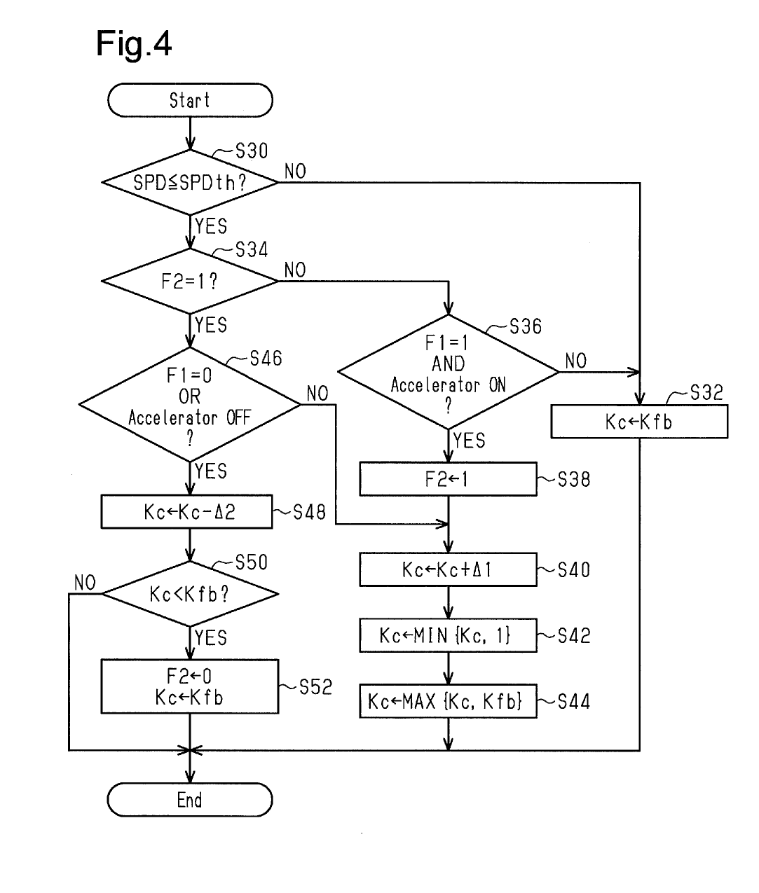

FIG. 4 shows the procedure of the correction coefficient calculating process M22. The process shown in FIG. 4 is executed by the CPU 62 repeatedly executing programs stored in the ROM 64 at a predetermined interval.

In the series of processes shown in FIG. 4, the CPU 62 first determines whether the vehicle speed SPD is lower than or equal to the specified speed SPDth, which has been used in the process of S12 (S30). When determining that the vehicle speed SPD exceeds the specified speed SPDth (S30: NO), the CPU 62 substitutes the feedback operation amount Kfb for the correction coefficient Kc (S32). In contrast, when determining that the vehicle speed SPD is lower than or equal to the specified speed SPDth (S30: YES), the CPU 62 determines whether an assist emphasizing flag F2 is 1 (S34). When determining that the assist emphasizing flag F2 is 0 (S34: NO), the CPU 62 determines whether the following two conditions are met: the condition that the assist flag F1 is 1; and the condition that the accelerator pedal has been operated (the accelerator is ON) (S36). When determining that the two conditions are not both met (S36: NO), the CPU 62 proceeds to the process of S32.

When determining that the above listed two conditions are both met (S36: YES), the CPU 62 sets the assist emphasizing flag F2 to 1 (S38). Then, the CPU 62 increases the correction coefficient Kc by an increase amount Δ1 (S40). This process is configured to gradually increase the correction coefficient Kc from the feedback operation amount Kfb to 1 by setting the assist emphasizing flag F2 to 1. Next, the CPU 62 substitutes the smaller one of the correction coefficient Kc and 1 for the correction coefficient Kc (S42). This process is configured to gradually increase the correction coefficient Kc and fix it at 1. Next, the CPU 62 substitutes the smaller one of the correction coefficient Kc and the feedback operation amount Kfb for the correction coefficient Kc (S44). This process is configured to limit the correction coefficient Kc to a value greater than or equal to the feedback operation amount Kfb.

In contrast, when determining that the assist emphasizing flag F2 is 1 (S 34: YES), the CPU 62 determines whether at least one of the following two conditions is met: the condition that the assist flag F1 is 0; and the condition that the accelerator pedal has been released (the accelerator is OFF) (S46). When determining that neither of the two conditions is met (S46: NO), the CPU 62 proceeds to the process of S40.

In contrast, when determining that at least one of the above two conditions is met (S46: YES), the CPU 62 decreases the correction coefficient Kc by a decrease amount Δ2 (S48). This process is configured to gradually decrease the correction coefficient Kc to the feedback operation amount Kfb. Next, the CPU 62 determines whether the correction coefficient Kc is smaller than the feedback operation amount Kfb (S50). When determining that the feedback operation amount Kfb is smaller than the feedback operation amount Kfb (S50: YES), the CPU 62 substitutes 0 for the assist emphasizing flag F2 and substitutes the feedback operation amount Kfb for the correction coefficient Kc (S52).

When the processes of S32, S44, S52 are complete or when the determination is negative in the process of S50, the CPU 62 temporarily ends the series of processes shown in FIG. 4.

An operation of the present embodiment will now be described.

When the clutch pedal 50 is operated to start the vehicle, if the accelerator operation amount ACCP by the user is small or the accelerator operation by the user is not performed, the CPU 62 substitutes the idle required torque Tisc for the required torque Trq*, which is input to the throttle operating process M28. Then, when the clutch 40 is in the transition period from the disengaged state to the engaged state, the CPU 62 sets the idle required torque Tisc in accordance with the assist torque Tas. In particular, when the accelerator is operated, the CPU 62 sets the correction coefficient Kc to 1. Accordingly, the idle required torque Tisc is prevented from falling below the base torque Tb even if the rotational speed NE exceeds the target rotational speed NE* and the feedback operation amount Kfb becomes smaller than 1. This allows the assist torque Tas based on the clutch load torque to be sufficiently reflected on the required torque Trq*.

Thereafter, when the assist torque Tas becomes zero, the CPU 62 gradually decreases the correction coefficient Kc to the feedback operation amount Kfb. Thus, an abrupt decrease in the idle required torque Tisc is limited as compared with a case in which the correction coefficient Kc is decreased in a stepwise manner from 1 to the feedback operation amount Kfb when the assist torque Tas becomes zero. This prevents the torque of the internal combustion engine 10 from being abruptly decreasing. Accordingly, the vehicle acceleration will not drop abruptly, so that the user will not experience discomfort.

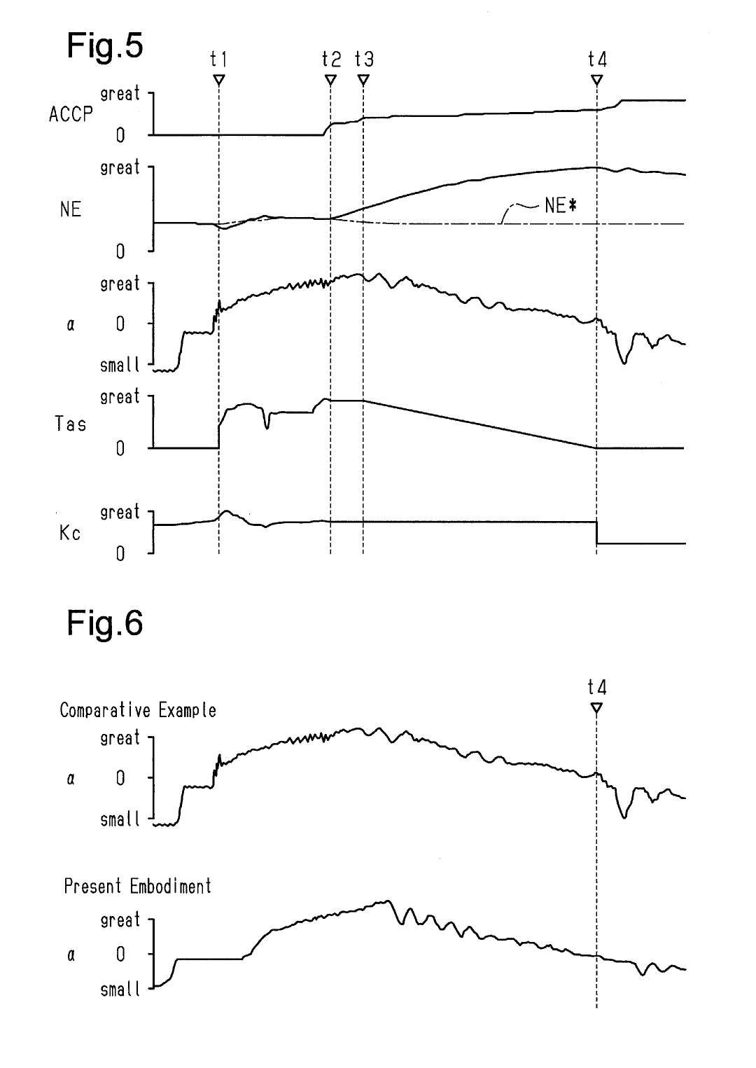

FIG. 5 shows changes in the accelerator operation amount ACCP, the rotational speed NE, the acceleration α, the assist torque Tas, and the correction coefficient Kc in a comparative example in which the assist torque Tas becomes zero, so that the correction coefficient Kc is decreased in a stepwise manner to the feedback operation amount Kfb from 1. As shown in FIG. 5, after the assist torque Tas rises at a point in time t1, it is determined that the accelerator has been operated at a point in time t2. Accordingly, the correction coefficient Kc is fixed at 1. Thereafter, when it is determined that the transition period is complete and the clutch 40 is in the engaged state at a point in time t3, the assist torque Tas decreases gradually. Then, the assist torque Tas becomes zero at a point in time t4, so that the correction coefficient Kc changes in a stepwise manner to the feedback operation amount Kfb. In this case, the acceleration α of the vehicle drops, which may cause the user to experience discomfort.

In contrast, as shown in FIG. 6, which compares the changes in the acceleration α in the comparative example shown in FIG. 5 with the changes in the acceleration α in the present embodiment, the present embodiment prevents the drop of the acceleration a after the assist torque Tas becomes zero.

The present embodiment described above further has the following advantages.

(1) The execution condition of a fixing process of fixing the correction coefficient Kc at 1 includes condition that the accelerator is operated. As a result, when the accelerator is not operated, the rotational speed NE of the crankshaft 28 can be controlled to the target rotational speed NE* by correcting the base torque Tb with the feedback operation amount Kfb. Thus, even when the load torque applied to the crankshaft 28 is abruptly changed, the rotational fluctuation of the crankshaft 28 is suppressed. In contrast, when the accelerator is operated, the user is assumed to intend to increase the torque of the internal combustion engine 10 even if the accelerator operation amount ACCP is small. Thus, if the base torque Tb is corrected to decrease with the feedback operation amount Kfb when the feedback operation amount Kfb becomes smaller than 1, the assisting performance is reduced, which may cause the user to experience discomfort. Therefore, by determining whether or not to execute the fixing process in accordance with the on/off state of the accelerator operation, it is possible to achieve compatibility between suppression of reduction in the assisting performance and suppression of rotational fluctuation.

(2) When the feedback operation amount Kfb is greater than 1, the feedback operation amount Kfb is used as the correction coefficient Kc, instead of fixing the correction coefficient Kc to 1. Thus, it is possible to deal with a situation in which the base torque Tb raised by the assist torque Tas is insufficient in relation to the adequate torque at the time of starting, for example, when the vehicle comes to an uphill road as the vehicle starts moving.

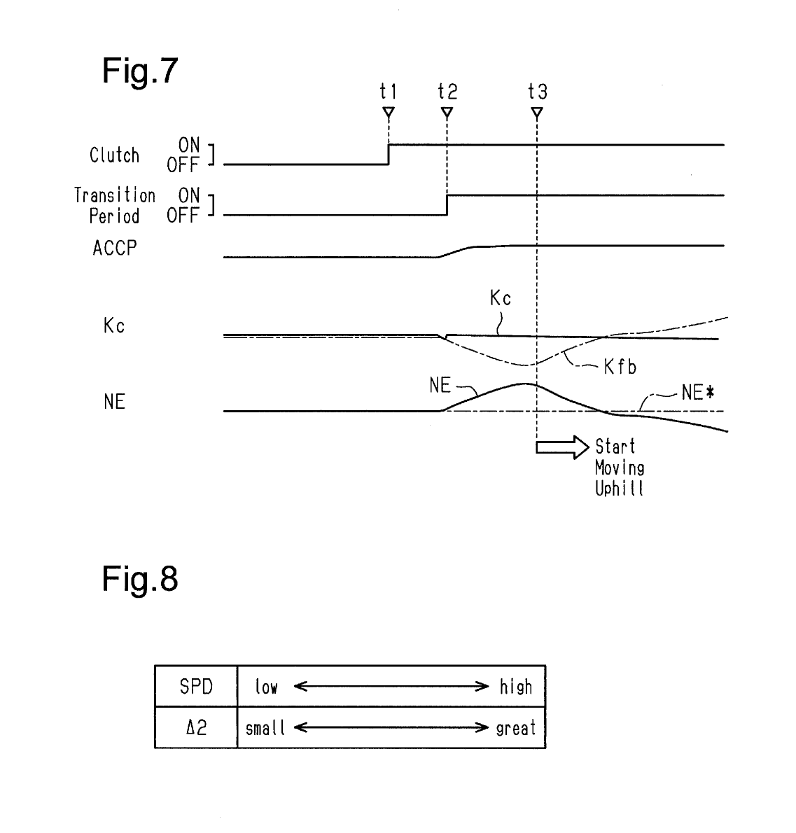

FIG. 7 shows changes in the on/off state of the clutch 40, changes in the result of the results of determination process in the transition period, and the changes in the accelerator operation amount ACCP, the correction coefficient Kc, and the rotational speed NE. As shown in FIG. 7, it is determined that the transition period begins at the point in time t2, after the clutch 40 is turned on at the point in time t1. Thereafter, when the vehicle enters an uphill road at the point in time t3, the rotational speed NE decreases, so that the feedback operation amount Kfb increases to be greater than 1. At this time, if the correction coefficient Kc is fixed at 1, it is impossible to deal with the drop in the rotational speed NE.

(3) If the feedback operation amount Kfb is smaller than 1 when the assist emphasizing flag F2 becomes 1, the correction coefficient Kc is gradually increased from the value of the feedback operation amount Kfb to 1. This allows for a gradual increase in the idle required torque Tisc, so that it is possible to suppress abrupt change in the torque of the internal combustion engine 10 as compared with a case in which the correction coefficient Kc is changed in a stepwise manner to 1.

(4) The assist torque Tas is calculated to be greater when the decrease rate of the rotational speed NE of the crankshaft 28 is high than when it is low. This allows the assist torque Tas to be set to a value corresponding to the clutch load torque.

(5) The torque of the internal combustion engine 10 is controlled in accordance with the greater one of the idle required torque Tisc and the accelerator required torque Tac. Thus, even when the accelerator operation is performed and the accelerator operation amount ACCP is excessively small, it is possible to prevent the user from experiencing discomfort. That is, if the accelerator operation amount ACCP is excessively small when the calculation of the feedback operation amount Kfb is stopped through operation of the accelerator, the torque of the internal combustion engine 10 may become smaller than when the torque is controlled in accordance with the idle required torque Tisc without operation of the accelerator. In such a case, there is a possibility that the user will experience discomfort about operation of the accelerator.

### Second Embodiment

A second embodiment will now be described with reference to the drawings. The differences from the first embodiment will mainly be discussed.

In the present embodiment, when the correction coefficient Kc is gradually decreased toward the feedback operation amount Kfb by setting the assist torque Tas to zero, the gradual decrease rate is set variably in accordance with the vehicle speed SPD.

FIG. 8 shows the relationship between the vehicle speed SPD and the decrease amount Δ2 according to the present embodiment. As shown in FIG. 8, the decrease amount Δ2 is set to a smaller value when the vehicle speed SPD is low than when the vehicle speed SPD is high in the present embodiment. As a result, the decrease rate of the correction coefficient Kc is smaller when the vehicle speed SPD is low than when the vehicle speed SPD is high. This configuration is aimed at preventing the user from having an impression of insufficient torque by reducing the gradual decrease rate of the correction coefficient Kc when the vehicle speed SPD is low.

Specifically, the decrease amount Δ2 can be calculated simply by storing map data having the vehicle speed SPD as an input variable and the decrease amount Δ2 as an output variable in the ROM 64 and causing the CPU 62 to perform map calculation. The map data refers to a data set of discrete values of the input variable and values of the output variable each corresponding to a value of the input variable. When the value of an input variable matches any of the values of the input variable on the map data, the map calculation uses the value of the corresponding output variable on the map data as the calculation result. When the value of the input variable does not match any of the values of the input variable on the map data, the map calculation uses a value obtained by interpolation of multiple values of the output variable included in the map data set as the calculation result.

### Correspondence

The correspondence between the items in the above embodiments and the items described in the above SUMMARY is as follows. Below, the correspondence is shown for each of the numbers in the above SUMMARY.

In Example 1, the torque control process corresponds to the maximum value selecting process M26 and the throttle operating process M28, the assist process corresponds to the process of the assist torque calculating process M16 and the adding process M18, the fixing process corresponds to the process of S42, and the gradual decrease process corresponds to the process of S48.

Example 2 corresponds to the process of S36.

Example 3 corresponds to the process of S44.

In Example 4, the gradual increase process corresponds to the process of S40.

Example 5 corresponds to the process of FIG. 3.

Example 7 corresponds to setting of the decrease amount Δ2 shown in FIG. 8.

### Other Embodiments

At least one feature of the above-illustrated embodiment may be modified as follows.

### Regarding Assist Process

In the above-illustrated embodiment, prior to the gradual decrease process of the assist torque Tas, the assist torque Tas is set to a larger value when the decrease rate of the rotational speed NE is high than when it is low, but the configuration is not limited to this. For example, a sensor for detecting the stroke of the clutch pedal 50 may be provided, and the assist torque Tas may be set in accordance with the detected value of the stroke.

In the above-illustrated embodiment, when the engagement of the clutch 40 is complete, the assist torque Tas is gradually decreased to zero, but the configuration is not limited to this. For example, a process may be employed in which the assist torque Tas is reduced to a predetermined value greater than 0. In this case, the assist flag F1 simply needs to be set to zero when the assist torque Tas becomes the predetermined value. Further, the assist torque Tas may be gradually decreased to zero on condition that the rotational speed NE increases by at least a predetermined amount.

The gradual decrease process of the assist torque Tas does not necessarily need to be executed, but the assist torque Tas may be decreased in a stepwise manner to a value not less than zero.

### Regarding Feedback Process

In the above-illustrated embodiment, the feedback operation amount Kfb is set to the value obtained by dividing the target rotational speed NE* by the rotational speed NE, but the configuration is not limited to this. For example, the feedback operation amount Kfb may be set to a value obtained by multiplying the difference between the target rotational speed NE* and the rotational speed NE by a proportional gain. Further, the feedback operation amount Kfb may be set to the sum of the output values of a derivative element and a proportional element that have, as the input, the difference between the target rotational speed NEf* and the rotational speed NE.

### Regarding Fixing Process

In the above-illustrated embodiment, the fixing process is a process of fixing the correction coefficient Kc at 1, which is a specified value, but the specified value is not limited to 1 but may be 0.99, for example.

In the above-illustrated embodiment, the fixing process is configured such that, when the feedback operation amount Kfb is greater than the specified value, the feedback operation amount Kfb is used, but the configuration is not limited to this. That is, the fixing process may be configured such that the correction coefficient Kc is fixed at the specified value regardless of the value of the feedback operation amount Kfb.

In the above-illustrated embodiment, the termination condition of the fixing process is that at least one of the following two conditions is met: the condition that the assist flag F1 is 0; and the condition that the accelerator operation is off. However, the configuration is not limited to this. For example, the termination condition of the fixing process may only be the condition that the assist flag F1 becomes 0.

In the above-illustrated embodiment, the fixing process is executed on condition that the accelerator is turned on, but the configuration is not limited to this. For example, the condition of the fixing process may only be the condition that the assist flag F1 becomes 1. In other words, only the condition that the assist torque Tas becomes greater than 0 may be used as the condition of the fixing process.

### Regarding Gradual Increase Process

In the above-illustrated embodiment, the gradual increase rate is set to a fixed value by setting the increase amount Δ1 to a fixed value. For example, the gradual increase rate may be variably set in accordance with the vehicle speed SPD. This can be implemented by using the map calculation described in the second embodiment.

### Regarding Required Torque of Internal Combustion Engine

In the above-illustrated embodiment, the greater one of the accelerator required torque Tac and the idle required torque Tisc is used as the required torque of the internal combustion engine 10, but the configuration is not limited to this. For example, a value obtained by adding the idle required torque Tisc to the accelerator required torque Tac0, which is calculated by the accelerator required torque calculating process M10, may be used as the required torque of the internal combustion engine 10.

### Regarding Determination Process in Transition Period

In the above-illustrated embodiment, whether or not the clutch 40 is in the transition period is determined based on the difference between the rotational speed NE of the crankshaft 28 and the rotational speed Nin of the input shaft 42, but the configuration is not limited to this. For example, a sensor for detecting the stroke of the clutch pedal 50 may be provided, and whether or not the clutch 40 is in the transition period may be determined based on the value of the stroke detected by the sensor.

### Regarding Determination of Accelerator Operation

In the above-illustrated embodiment, whether the accelerator is being operated is determined based on the accelerator operation amount ACCP detected by the accelerator sensor 76, but the configuration is not limited to this. For example, a sensor that binarily determines whether an accelerator operation is being performed may be provided, and the detection value of that sensor may be used.

### Regarding Controller

The controller is not limited to a device that includes the CPU 62 and the ROM 64 and executes software processing. For example, at least part of the processes executed by the software in the above-illustrated embodiment may be executed by hardware circuits dedicated to executing these processes (such as ASIC). That is, the controller may be modified as long as it has any one of the following configurations (a) to (c). (a) A configuration including a processor that executes all of the above-described processes according to programs and a program storage device such as a ROM that stores the programs. (b) A configuration including a processor and a program storage device that execute part of the above-described processes according to the programs and a dedicated hardware circuit that executes the remaining processes. (c) A configuration including a dedicated hardware circuit that executes all of the above-described processes. A plurality of software processing circuits each including a processor and a program storage device and a plurality of dedicated hardware circuits may be provided. That is, the above processes may be executed in any manner as long as the processes are executed by processing circuitry that includes at least one of a set of one or more software processing circuits and a set of one or more dedicated hardware circuits.

### Other Modifications

The internal combustion engine is not limited to a spark-ignition engine. For example, the internal combustion engine may be a compression ignition engine such as a diesel engine. In this case, a process for adjusting the injection amount in accordance with the required torque needs to be performed instead of the throttle operating process M28.

The process of S30 in FIG. 4 may be deleted. Also, the condition that the vehicle speed SPD is equal to or lower than the specified speed SPDth may be deleted from the process of S12 in FIG. 3.

Therefore, the present examples and embodiments are to be considered as illustrative and not restrictive and the disclosure is not to be limited to the examples and embodiments given herein.

1. A controller for an internal combustion engine being configured to control a vehicle internal combustion engine having a crankshaft connected to a manual transmission via a clutch, the controller being configured to execute:
a feedback process of calculating a feedback operation amount, which is an operation amount used to perform feedback control to set a rotational speed of the crankshaft of the internal combustion engine to a target rotational speed;
a torque control process of controlling a torque of the internal combustion engine by using, as an input, an idle required torque, which is a value obtained by multiplying a base torque by a correction coefficient;
an assist process of raising the base torque by an assist torque, which is a torque used to limit a decrease in the rotational speed of the crankshaft that accompanies transition of the clutch from a disengaged state to an engaged state;
a fixing process of fixing the correction coefficient at a specified value on condition that the clutch is in a transition period from the disengaged state to the engaged state; and
a gradual decrease process of stopping the fixing process and gradually decreasing the correction coefficient to the feedback operation amount when the fixing process is executed and the assist torque is smaller than or equal to a predetermined value.

2. The controller for an internal combustion engine according to claim 1, wherein
the fixing process is a process of fixing the correction coefficient at the specified value when following two conditions are met: a condition that the clutch is in the transition period; and a condition that an accelerator is being operated, and
the controller is configured to use the feedback operation amount as the correction coefficient when the fixing process is not executed.

3. The controller for an internal combustion engine according to claim 1, the controller being configured to
execute the fixing process on condition that the feedback operation amount is smaller than a specified value, and
in a case in which the feedback operation amount is greater than the specified value, use the feedback operation amount as the correction coefficient even if the clutch is in the transition period.

4. The controller for an internal combustion engine according to claim 1, wherein the controller is configured to, in a case in which the feedback operation amount is smaller than the specified value, execute a gradual increase process of gradually increasing the correction coefficient from the value of the feedback operation amount to the specified value prior to starting of the fixing process.

5. The controller for an internal combustion engine according to claim 1, wherein the assist process includes a process of
during the transition period, calculating the assist torque to be a greater value when a decrease rate of the rotational speed of the crankshaft is high than when the decrease rate is low, and
gradually decreasing the assist torque to zero when the transition period is complete and the clutch is in the engaged state.

6. The controller for an internal combustion engine according to claim 1, wherein
the controller is configured to execute an accelerator required torque calculation process of calculating an accelerator required torque of the internal combustion engine in accordance with an accelerator operation amount, and
the torque control process includes a process of
using the accelerator required torque as an input in addition to the idle required torque, and
controlling the torque of the internal combustion engine in accordance with a greater one of the idle required torque and the accelerator required torque.

7. The controller for an internal combustion engine according to claim 1, wherein the gradual decrease process includes a process of setting a gradual decrease rate of the correction coefficient to a smaller value when a vehicle speed is low than when the vehicle speed is high.

8. A method of controlling a vehicle internal combustion engine having a crankshaft connected to a manual transmission via a clutch, the method comprising:
executing a feedback process of calculating a feedback operation amount, which is an operation amount used to perform feedback control to set a rotational speed of the crankshaft of the internal combustion engine to a target rotational speed;
executing a torque control process of controlling a torque of the internal combustion engine by using, as an input, an idle required torque, which is a value obtained by multiplying a base torque by a correction coefficient;
executing an assist process of raising the base torque by an assist torque, which is a torque used to limit a decrease in the rotational speed of the crankshaft that accompanies transition of the clutch from a disengaged state to an engaged state;
executing a fixing process of fixing the correction coefficient at a specified value on condition that the clutch is in a transition period from the disengaged state to the engaged state; and
executing a gradual decrease process of stopping the fixing process and gradually decreasing the correction coefficient to the feedback operation amount when the fixing process is executed and the assist torque is smaller than or equal to a predetermined value.

9. A controller for an internal combustion engine being configured to control a vehicle internal combustion engine having a crankshaft connected to a manual transmission via a clutch, wherein
the controller comprises processing circuitry, and
the processing circuitry is configured to execute
a feedback process of calculating a feedback operation amount, which is an operation amount used to perform feedback control to set a rotational speed of the crankshaft of the internal combustion engine to a target rotational speed;
a torque control process of controlling a torque of the internal combustion engine by using, as an input, an idle required torque, which is a value obtained by multiplying a base torque by a correction coefficient;
an assist process of raising the base torque by an assist torque, which is a torque used to limit a decrease in the rotational speed of the crankshaft that accompanies transition of the clutch from a disengaged state to an engaged state;
a fixing process of fixing the correction coefficient at a specified value on condition that the clutch is in a transition period from the disengaged state to the engaged state; and
a gradual decrease process of stopping the fixing process and gradually decreasing the correction coefficient to the feedback operation amount when the fixing process is executed and the assist torque is smaller than or equal to a predetermined value.
